(19) United States
(12) Patent Application Publication
(10) Pub. No.: US 2005/0285463 A1
(43) Pub. Date: Dec. 29, 2005

(54) Brush assemblies

(76) Inventors: Shepard Lynn Hockaday, Benson, NC (US); George David Corn JR., Brandon, MS (US); David Summers, Winona, MS (US); Pimol Ballard Vonkchalee, Apex, NC (US)

Correspondence Address: McCarter & English LLP, Four Stamford Plaza, 107 Elm Street, Stamford, CT, 06902, US

(21) Appl. No.: 10/880,133

(22) Filed: Jun. 29, 2004

(51) Int. Cl. H02K 11/00

(52) U.S. Cl. 310/71; 310/239

(57) ABSTRACT

Detailed are brush assemblies for electric motors. The assemblies may include lead frames to which leaded electrical components are mounted directly. The lead frames additionally may include two or more conductors and be positioned remote from the brushes of the assemblies.

### FIELD OF THE INVENTION

This invention relates to brush assemblies for electric motors and more particularly, although not necessarily exclusively, to such assemblies in which leaded electrical components are mounted directly to lead frames.

### BACKGROUND OF THE INVENTION

Brush assemblies for use as parts of electric motors are disclosed in numerous patents. Two of many examples of such patents are U.S. Pat. No. 6,664,701 to Ortt, et al. and U.S. Pat. No. 5,990,594 to Hyatt, Jr., et al., the contents of which are incorporated herein in their entireties by this reference. Considered generally, such assemblies house brushes which, in operation, contact a commutator to complete an electrical circuit between the commutator and a power source and cause the commutator to rotate.

Some existing brush assemblies include brush card housings in which electrical components are mounted, typically for radio-frequency interference (RFI) suppression. Examples of such components include inductors and varistors, either or both of which may be mounted adjacent the brushes of an assembly and connected relatively directly thereto. These mountings may be difficult to effect, however, given the geometries and space limitations of the housings involved. Mounting the components in this manner likewise may be more expensive than optimal.

Recent alternative approaches to these existing mountings attempt to relocate the electrical components farther from the brushes and their associated housing so as to avoid close proximity to high temperatures. One such relocation approach involves mounting electrical components to a printed circuit board (PCB) and connecting the PCB to a lead frame forming part of the brush card assembly. Existing space limitations mandate that the electrical components be surface-mount, rather than leaded, devices, however. These limitations result in inadequate performance of the RFI suppression components in certain conditions.

Another approach, recently devised for certain fuel pump modules, includes mounting a single leaded electrical component directly to a two-conductor lead frame. Retainer guides extending opposite the legs of the lead frame are utilized to guide insertion of the component and thereafter maintain its position during various manufacturing processes. Although preferable in some respects to other approaches, this approach—with retainer guides and only two-conductor lead frames—is not optimal for at least some brush assemblies.

### SUMMARY OF THE INVENTION

The present invention seeks to resolve issues arising with these and other mounting approaches. Consistent with some approaches, those of the present invention involve relocating electrical components away from brushes and adjacent the lead frame of a brush card assembly. Instead of utilizing a PCB, however, approaches of the invention include directly mounting components to the lead frame. Similarly, rather than relocating only one component to the vicinity of a two-conductor lead frame, the present invention comprises mounting multiple such components to a three-conductor lead frame. Although retainer guides conceivably could be utilized as part of the invention, they need not necessarily be used because of differing manufacturing processes also to be employed.

Presently preferred manufacturing techniques associated with the invention permit pre-assembly of the lead frame. As a result, multiple leaded electrical components may be securely connected to the lead frame prior to its incorporation into the brush card assembly. Thereafter, the pre-assembled lead frame may have a housing molded around it or be placed into a cavity of a pre-molded brush card housing and a cover molded over the lead frame. Brushes, springs, and other ancillary equipment then may be added within the housing and all electrical connections welded or soldered together. Because the electrical components of the lead frame need be stabilized only during the overmolding process, tooling associated with the molding (rather than retainer guides) may effect any needed stabilization of the components.

At least one brush card assembly consistent with the present invention includes integral brush card and lead frame housings. Incorporated into the brush card housing are (at least) two brushes and associated biasing mechanisms such as springs. Also included in the brush card housing and electrically connected to the brushes is a thermal circuit breaker designed to cease current flow should its temperature reach a selected threshold.

Removed from the brush card housing in this embodiment are all electrical components typically used for RFI suppression. The components instead are welded, or otherwise mounted, directly to a lead frame. Additionally, the lead frame is designed to include three conductors (plus, minus, and “ground”), with the ground conductor preferably (but not necessarily) positioned intermediate the others. For the particular components likely to be utilized in connection with commercial versions of the invention, this design facilitates their mounting to the lead frame. Blades of the lead frame are electrically connected to the brushes of the assembly, while the legs connect ultimately to a power source and the ground conductor connects to the motor can itself. Two-conductor lead frames may be utilized instead of the three-conductor versions mentioned above, however, as may lead frames having more than three conductors (if necessary or desired).

It thus is an optional, non-exclusive object of the present invention to provide brush card assemblies in which leaded electrical components are mounted directly to lead frames.

It is another optional, non-exclusive object of the present invention to provide brush card assemblies in which lead frames having two or more conductors are employed.

It also is an optional, non-exclusive object of the present invention to provide brush card assemblies in which lead frames may be pre-assembled and which retainer guides need not necessarily be utilized.

It is a further optional, non-exclusive object of the present invention to provide brush card assemblies omitting PCBs and surface-mount components yet continuing to provide RFI suppression.

It is, moreover, an optional, non-exclusive object of the present invention to provide RFI suppression components mounted in a lead frame housing remote from the brushes of the brush card assembly.

Other objects, features, and advantages of the present invention will be apparent to those skilled in the appropriate art with reference to the remaining text and drawings of this application.

### BRIEF DESCRIPTION OF THE DRAWINGS

FIG. 1 illustrates, in plan view, an exemplary brush card assembly of the present invention together with a commutator.

FIG. 2 is a cross-sectional view of the brush card assembly (and commutator) taken along lines C-C of FIG. 1.

FIG. 3 is an isometric view of a lead frame, to which electrical components have been mounted, which may form part of the brush card assembly of FIG. 1.

FIG. 4 is a plan view of the lead frame of FIG. 3.

FIG. 5 is an elevational view of the lead frame of FIG. 3.

FIG. 6 is a plan view of the lead frame of FIG. 3 showing portions of the lead frame opposite those depicted in FIG. 4.

### DETAILED DESCRIPTION

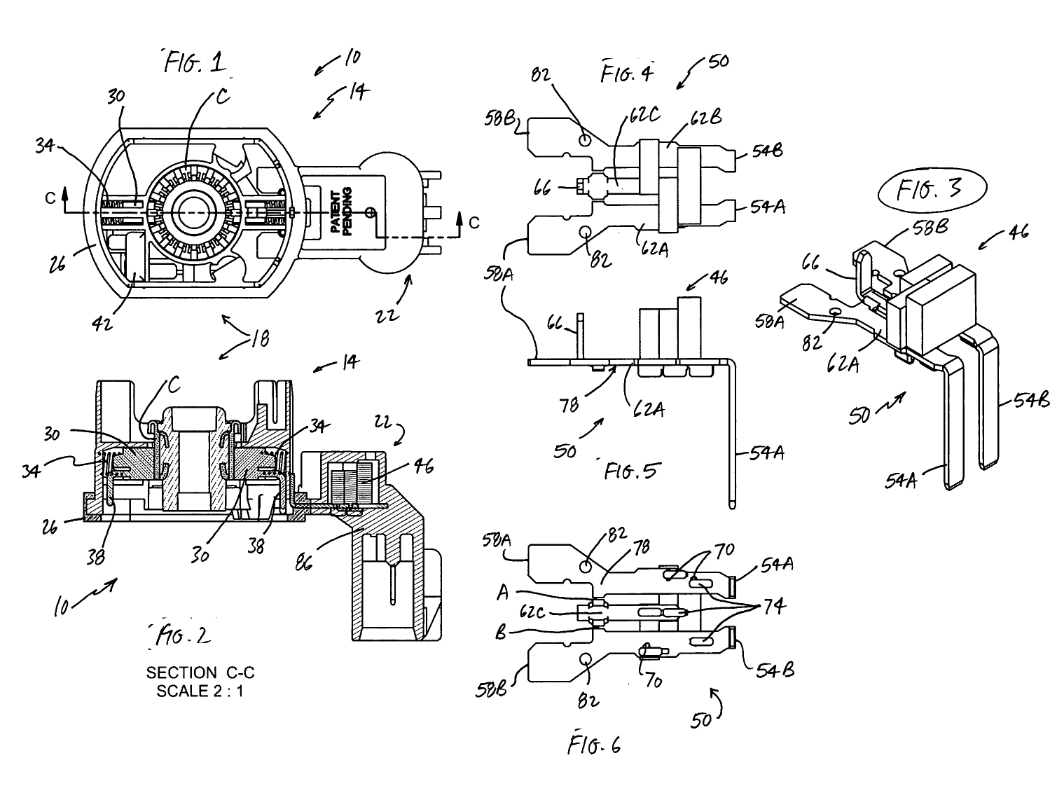

Shown in FIGS. 1-2 is an exemplary brush card assembly 10 of the present invention together with commutator C of an electric motor. Assembly 10 includes housing 14, which may comprise brush card housing 18 and lead frame housing 22. Housing 14 preferably is formed of molded plastic or other thermoplastic material that is electrically insulating, although other materials may be utilized instead if appropriate or desired. Additionally, brush card housing 18 and lead frame housing 22 preferably are integrally formed, although they need not necessarily be so created.

Also depicted in FIGS. 1-2 is seal material 26. Frequently made of Santoprene, seal material 26 is friction fitted or otherwise attached to housing 14. When assembly 10 is positioned within a device for use as part of an electric motor, material 26 may effectively seal against a surface of the device and thereby inhibit debris from entering housing 14. Those skilled in the relevant art will recognize that seal material 26 need not necessarily be made of Santoprene and need not necessarily form part of assembly 10, particularly if other means for inhibiting entry of debris into housing 14 exist.

Positioned within brush card housing 18 may be brushes 30, two of which are detailed in FIGS. 1-2, and associated springs 34. As is already well known, springs 34 function to bias brushes 30 into contact with commutator C. Wires 38 serve to convey electricity to brushes 30, the output of one of which may be connected via thermal breaker 42. Breaker 42, if present, operates to open the electrical circuit including brushes 30 if its temperature passes a selected threshold.

Absent from the version of brush card housing 18 illustrated in FIGS. 1-2 are any inductors or varistors typically employed for RFI suppression. Instead, electrical components 46 in the form of capacitors preferably provide this suppression and are positioned within lead frame housing 22. Such components 46, whether or not capacitors, advantageously are leaded and, for example, are not surface-mounted to a PCB.

Detailed in FIGS. 3-6 is lead frame 50. Lead frame 50 is housed within lead frame housing 22 and is beneficially made of tin-plated copper, although other electrically-conductive materials may be used instead. Forming parts of lead frame 50 are legs 54A and 54B, blades 58A and 58B, and conductors 62A, 62B, and 62C. Conductor 62A connects leg 54A to blade 58A, while conductor 62B connects leg 54B to blade 58B. Conductor 62C, by contrast, preferably connects to an associated motor can via connector 66. During the manufacturing process, portions of lead frame 50 marked “A” and “B” may be removed in order to isolate electrically each of conductors 62A, 62B, and 62C from the others.

As noted in FIGS. 3-6, components 46 and connector 66 extend from conductors 62A-C in the direction opposite legs 54A-B. However, because conductors 62A-C include lead holes 70, leads 74 of electrical components 46 may extend through the holes 70 and be welded, or otherwise connected, to the side 78 from which legs 54A-B protrude. Depending on the application for assembly 10, holes 70 may be either custom-formed in lead frame 50 or generically cut therein.

Blades 58A-B extend into brush card housing 18, each for electrical connection (direct or indirect) to a brush 30. Blades 58A-B optionally may include guide holes 82 useful for aligning tooling or other equipment during manufacturing processes. Legs 54A-B are adapted for connection to a source of electrical power so as to allow current to flow to brushes 30 and cause commutator C to rotate. Preferably legs 54A-B are inserted into openings in a molded connector housing, although they may be electrically connected in any suitable manner to the power source.

Assembly 10 may be manufactured using any appropriate process. Beneficially, however, lead frame 50 may be created (with portions “A” and “B” intact) and connected to electrical components 46 prior to being positioned within housing 14. Pre-assembling lead frame 50 and components 46 avoids, among other things, having to weld components 46 within the small area available to do so after lead frame 50 is included within lead frame housing 22.

Assembled lead frame 50 may then be positioned within cavity 86 (see FIG. 2) of lead frame housing 22 as the housing 22 is molded around the lead frame 50. Typically thereafter, seal material 26 will be added if to be included as part of assembly 10. Because, by this time, handling of electronic components 46 is complete, only brushes 30, springs 34, thermal breaker 42, and their associated wiring need be inserted into brush card housing 18. Completing the wiring connections and coupling the wiring to blades 58A and 58B finishes electrical circuitry associated with assembly 10.

The foregoing is provided for purposes of illustrating, explaining, and describing exemplary embodiments and certain benefits of the present invention. Modifications and adaptations to the illustrated and described embodiments will be apparent to those skilled in the relevant art and may be made without departing from the scope or spirit of the invention.

1. A brush assembly for an electrical motor, the brush assembly comprising:
a. a housing;
b. a brush positioned, at least in part, in the housing;
c. a multi-conductor lead frame directly or indirectly electrically connected to the brush; and
d. a plurality of leaded electrical components mounted on the lead frame.

2. A brush assembly according to claim 1 in which the lead frame includes three conductors.

3. A brush assembly according to claim 2 in which at least one of the electrical components is a capacitor.

4. A brush assembly according to claim 1 in which:
a. the housing comprises (i) a brush card housing and (ii) a lead frame housing;
b. the brush is positioned within the brush card housing; and
c. the lead frame and electrical components are positioned, at least in part, within the lead frame housing.

5. A brush assembly according to claim 4 in which:
a. the electrical components provide radio-frequency interference (RFI) suppression and;
b. no RFI suppressing component is included within the brush card housing.

6. A brush assembly according to claim 1 further comprising a second brush positioned, at least in part, in the housing.

7. A brush assembly according to claim 1 in which:
a. the lead frame comprises a plurality of legs extending in a first direction; and
b. the electrical components extend from the lead frame in a direction opposite the first direction.

8. A method of manufacturing a brush assembly comprising:
a. providing a lead frame having greater than two conductors;
b. mounting a plurality of electrical components to the lead frame;
c. installing the lead frame and a plurality of brushes in a housing; and
d. directly or indirectly electrically connecting the lead frame to the brushes.

9. An electrical motor comprising:
a. a commutator; and
b. a brush assembly comprising:
i. a housing;
ii. a brush positioned, at least in part, in the housing;
iii. a multi-conductor lead frame directly or indirectly electrically connected to the brush; and
iv. a plurality of leaded electrical components mounted on the lead frame.
